(19) United States
(12) Patent Application Publication
(10) Pub. No.: US 2006/0218371 A1
(43) Pub. Date: Sep. 28, 2006

(54) The advanced memory optimization installation method for Microsoft operating systems (AMO)

(75) Inventor: Aldon P. Jarrett JR., Mount Dora, FL (US)

Correspondence Address: Aldon P Jarrett Jr., PO box 627, Mount Dora, FL, 32756, US

(73) Assignee: Mr. Aldon P. Jarrett JR., Mount Dora, FL (US)

(21) Appl. No.: 10/907,186

(22) Filed: Mar. 23, 2005

(51) Int. Cl. G06F 12/00

(52) U.S. Cl. 711/173; 711/112

(57) ABSTRACT

The configuration (partition and format) of the hard drive, in a computer system running a Microsoft® operating system, has a major impact on the overall performance of the system. A poorly configured (partitioned and formatted) hard drive negatively impacts the performance of the entire system and can cost a performance loss of 15% or more! The Advanced Memory Optimization Installation Method for Microsoft® Operating Systems addresses this issue by properly configuring (partitioning and formatting) the hard drive, causing it to perform at a higher level. Systems installed using the Advanced Memory Optimization Installation Method for Microsoft® Operating Systems out perform systems with the default Microsoft® formatting and installation, on identical equipment.

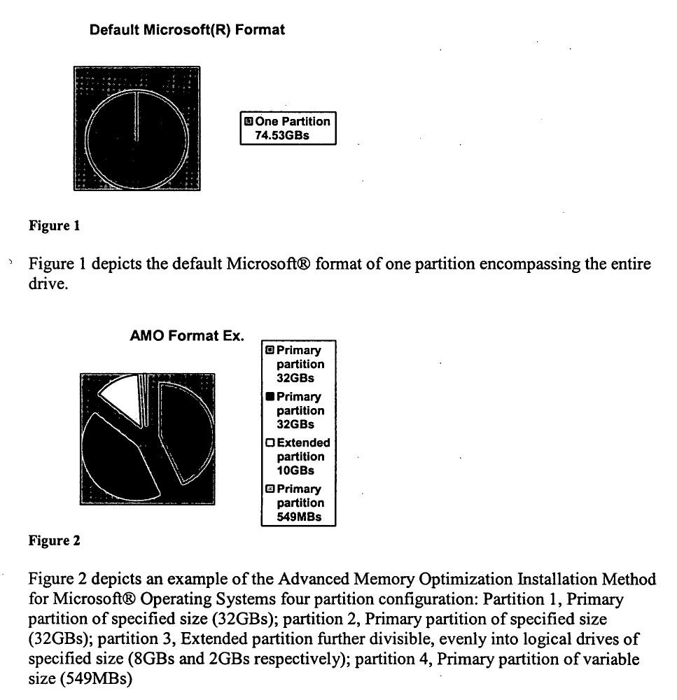

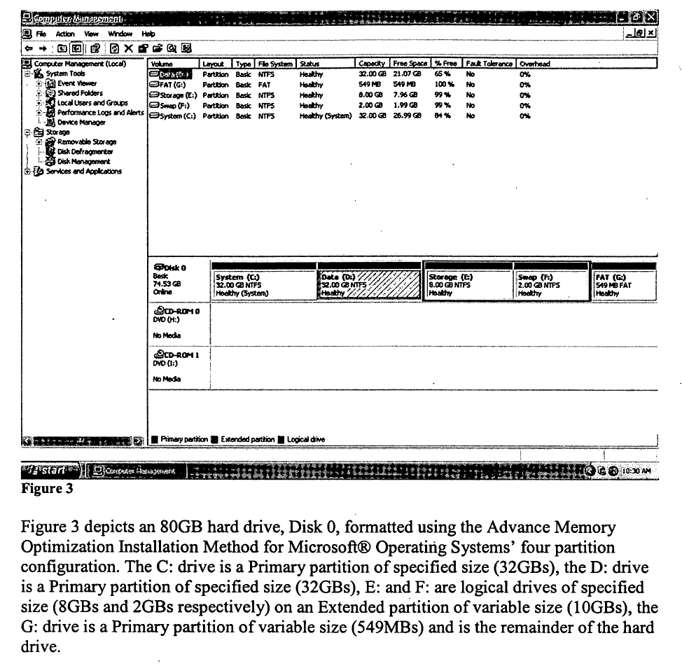

### FIELD OF INVENTION

The present invention relates to the field of installing and configuring Microsoft® operating systems on computer systems generally, and more specifically, to the manner in which the hard drive of the computer system is partitioned and formatted.

### DESCRIPTION OF THE RELATED ART

In the modern day computer system, every aspect of the systems memory is highly coordinated, requiring strict conformity to certain specifications. System memory for instance, must be installed using a specific type, size, and number of memory modules in order to achieve optimal performance and in some cases to perform at all (example: 1 GB of system RAM can be installed in a system in a number of ways; using a 1 GB memory module or 2 512 MB memory modules. The installation using 2 512 MB memory modules performs better than an installation using 1 1 GB memory module because the system is able to utilize DOUBLE DATA RATE TRANSFERS). This is true for every aspect of system memory except the hard drive, which until now, has been overlooked. Additionally, the hard drive remains the biggest bottleneck to system performance. Consequently, a need exists for a method of configuring (partitioning and formatting) a hard drive, to accelerate its performance, helping to alleviating the bottleneck it creates.

### SUMMARY OF THE INVENTION

One aspect of this invention is the method of configuring (partitioning and formatting), a hard drive in a computer system, of any size and with any hardware configuration, to which a Microsoft® operating system is to be installed. The method comprises the steps of:
(1) Start the installation process either from a Microsoft® operating system installation disk, from an installation disk located on a network, or from a master installation disk created to install a Microsoft® operating system to multiple systems of identical configuration; alternately, the installation process can be started using a third party partitioning utility such as Partition Magic®,
(2) Using either the embedded Microsoft® partitioning utility or a third party partitioning utility such as Partition Magic®, create and format an initial partition of the specified type and size to which the Microsoft® operating system will be installed.

Another aspect of this invention is the method of installing and configuring a Microsoft® operating system. The method comprises the steps of:
(1) Install the Microsoft® operating system to the initial partition, a Primary partition formatted to the desired file system previously created, with a specified size,
(2) Change the size of the Paging file from the default setting to the new setting,
(3) Change the default Registry Key “NonBestEffortLimit” setting from the default setting to the new setting,
(4) Add the Registry Key “loPageLockLimit” with the correct setting.

Still another aspect of this invention is the method of configuring (partitioning and formatting) the remaining unused space on the hard drive. The method comprises the steps of:
(1) Using either the Disk Management utility embedded in the Microsoft® operating system or a third party partitioning utility such as Partition Magic®, create and format a second partition according to the specification.
(2) Create and format a third partition according to the specification, if needed.
(3) Create and format a fourth partition according to the specification, if needed.

The above and other features of the present invention will be better understood with the included specifications and accompanying drawings.

What is claimed is:

1. (canceled)

2. A method of configuring (partitioning and formatting) a hard drive, on a computer system, of any size. and with any hardware configuration, to which a Microsoft® operating system is to be installed. The method comprising the steps of:
(a) Creating and formatting partitions of the appropriate number, type and size on the hard drive.
(b) Installing and configuring the Microsoft® operating system.
(c) Configuring and formatting the remaining unused space on the hard drive.

3. The method of claim 1, including, before step (a), the steps of:
(a) The hard drive in any computer system, of any size and with. any hardware configuration, to which a Microsoft® operating system will be installed.
(b) Any available method of partitioning and formatting a hard drive for use with a Microsoft® operating system either named or unnamed.
(c) Any available method of installing a Microsoft® operating system on an individual system or on multiple systems simultaneously either named or unnamed.

4. The method of claim 1, wherein step (a) includes the correct types of partitions created on the hard drive.

5. The method of claim 1, wherein step (a) includes the correct size of the partitions created on the hard drive.

6. The method of claim 1, wherein step (a) includes the correct number of partitions created on the hard drive.

7. The method of claim 1, wherein step (a) includes the correct file system format on the partitions created on the hard drive.

8. The method of claim 1, wherein step (b) includes any Microsoft® operating system.

9. The method of claim 1, wherein step (b) includes changes to certain settings from the default Microsoft® operating system settings.

10. The method of claim 1, wherein step (c) may be performed, before, during, or after the method of claim 1 step (b).

11. The method of claim 2, wherein step (a) includes hard drives 10 GBs in size or greater, connected to the rest of the computer system by any means, to which a Microsoft operating system will be installed.

12. The method of claim 2, wherein step (c) is performed on individual systems or multiple systems simultaneously, either manually or automatically.
